(19) United States
(12) Patent Application Publication
(10) Pub. No.: US 2025/0358399 A1
(43) Pub. Date: Nov. 20, 2025

(54) PROJECTION SYSTEM

(71) Applicant: TOYOTA JIDOSHA KABUSHIKI KAISHA, Aichi-ken (JP)

(72) Inventors: Hsuan-Kung YANG, Tokyo-to (JP); Tsu-Ching HSIAO, Tokyo-to (JP); Norimasa KOBORI, Tokyo-to (JP); Hitoshi KAMADA, Tokyo-to (JP); Daniel NEMCIK, Tokyo-to (JP); Naoya YOSHIMURA, Tokyo-to (JP); Ryuya NISHINO, Tokyo-to (JP); Betty Magali Claire LE DEM, Tokyo-to (JP); Yuki KAWANA, Tokyo-to (JP)

(21) Appl. No.: 19/190,793

(22) Filed: Apr. 28, 2025

(30) Foreign Application Priority Data
May 17, 2024 (JP) 2024-080694

(51) Int. Cl. H04N 13/383; G06F 3/01; G06T 7/246; H04N 13/117; H04N 13/243

(52) U.S. Cl. CPC H04N 13/383; G06F 3/017; G06T 7/251; H04N 13/117; G06T 2207/10021; H04N 13/243

(57) ABSTRACT

A projection system stores virtual space configuration information indicating a configuration of objects defined in a virtual target space representing a real target space. The projection system detects a real human shown in an image taken by a real camera installed in the real target space, and estimates a three dimensional pose of the real human based on the image. Then, the projection system projects a virtual human having the three dimensional pose and representing the real human onto the virtual target space. In addition, the projection system performs an action estimation process that estimates an action of the real human in the real target space by estimating an action of the virtual human in the virtual target space based on a relationship between the virtual human having the three dimensional pose and the configuration of the objects in the virtual target space.

### CROSS-REFERENCES TO RELATED APPLICATION

The present disclosure claims priority to Japanese Patent Application No. 2024-080694, filed on May 17, 2024, the contents of which application are incorporated herein by reference in their entirety.

### TECHNICAL FIELD

The present disclosure relates to a technique for projecting a human in a real target space onto a virtual target space.

### BACKGROUND ART

Patent Literature 1 discloses a gaze estimation system. The gaze estimation system acquires a series of images in which a face of a measurement target human is shown. Then, the gaze estimation system estimates a line-of-sight position of the measurement target human from the image including the face by using a learned model.

Patent Literature 2, Patent Literature 3, and Patent Literature 4 are known as technologies related to a virtual space.

### LIST OF RELATED ART

Patent Literature 1: Japanese Laid-Open Patent Application No. JP-2022-187547
Patent Literature 2: Japanese Laid-Open Patent Application No. JP-2024-003401
Patent Literature 3: Japanese Laid-Open Patent Application No. JP-2022-061305
Patent Literature 4: Japanese Laid-Open Patent Application No. JP-2010-176662

### SUMMARY

An image captured by a camera installed in a target space can be used for analyzing the target space. For example, an action of a human present in a target space can be estimated based on an image captured (taken) by a camera installed in the target space. It is desired to improve accuracy of human action estimation based on an image captured by a camera.

An aspect of the present disclosure is directed to a projection system.

The projection system includes one or more processors and one or more storage devices.

The one or more storage devices are configured to store virtual space configuration information indicating a configuration of objects defined in a virtual target space representing a real target space.

The one or more processors detect a real human shown in an image taken by a real camera installed in the real target space.

The one or more processors estimate a three dimensional pose of the real human based on the image.

The one or more processors project a virtual human having the three dimensional pose and representing the real human onto the virtual target space.

The one or more processors perform an action estimation process that estimates an action of the real human in the real target space by estimating an action of the virtual human in the virtual target space based on a relationship between the virtual human having the three dimensional pose and the configuration of the objects in the virtual target space.

According to the present disclosure, the three dimensional pose of the real human in the real target space is estimated, and the virtual human having the three dimensional pose and representing the real human is projected onto the virtual target space. Then, the action of the real human in the real target space is estimated by estimating the action of the virtual human in the virtual target space. Therefore, it is possible to estimate the action of the real human more accurately than in a case where the action of the real human is estimated directly from a two dimensional image.

### BRIEF DESCRIPTION OF DRAWINGS

FIG. 1 is a conceptual diagram for explaining an overview of a real-to-virtual projection system;

FIG. 2 is a conceptual diagram for explaining virtual space configuration information;

FIG. 3 is a conceptual diagram for explaining camera configuration information;

FIG. 4 is a conceptual diagram for explaining an overview of a visualization function and an analysis function;

FIG. 5 is a conceptual diagram for explaining an example of an image analysis module;

FIG. 6 is a conceptual diagram for explaining a method of improving accuracy of a localization process;

FIG. 7 is a conceptual diagram for explaining an example of a gaze estimation process;

FIG. 8 is a conceptual diagram for explaining an example of a grasp estimation process;

FIG. 9 is a conceptual diagram for explaining an example of a human flow estimation process; and

FIG. 10 is a conceptual diagram for explaining an example of a camera calibration and alignment process.

### DETAILED DESCRIPTION

Embodiments of the present disclosure will be described with reference to the accompanying drawings.

### 1. Overview of Real-to-Virtual Projection System

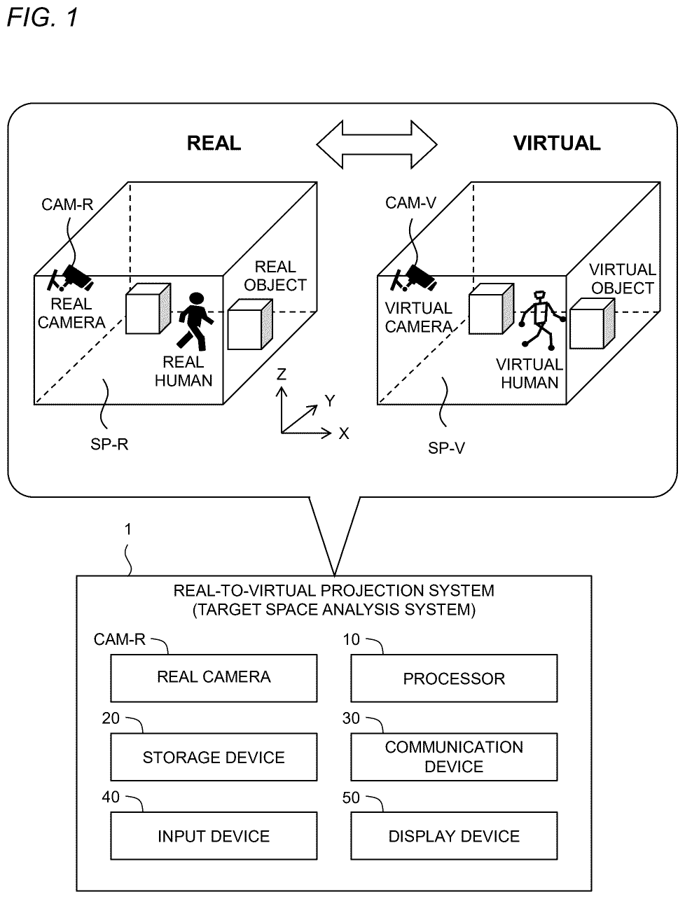

FIG. 1 is a conceptual diagram for explaining an overview of a real-to-virtual projection system 1. A real target space SP-R is an actual three dimensional space, and is a three dimensional space that is a target of various analyses. A virtual target space SP-V is a virtual three dimensional space representing the real target space SP-R. In other words, the virtual target space SP-V is a virtual three dimensional space that imitates (simulates) the real target space SP-R. The real target space SP-R and the virtual target space SP-V are represented in a same world coordinate system (X, Y, Z).

Various physical objects exist in the real target space SP-R. Examples of the physical object include a wall, a column, a door, a desk, a chair, a shelf, a box, a display, an electronic device, a tree, and the like. The physical object present in the real target space SP-R is hereinafter referred to as a real object. A virtual object corresponding to the real object is defined in the virtual target space SP-V. In other words, a virtual object that imitates the real object is defined in the virtual target space SP-V. A configuration of the real object in the real target space SP-R and a configuration of the virtual object in the virtual target space SP-V match with a certain level of accuracy or higher. Here, the term “configuration” used herein is a concept including a position, an orientation, a shape, a size, and the like.

In addition, one or more real cameras CAM-R are installed in the real target space SP-R. Each real camera CAM-R is a static camera (fixed camera). One or more virtual cameras CAM-V corresponding to the one or more real cameras CAM-R are installed in the virtual target space SP-V. The corresponding pair of one real camera CAM-R and one virtual camera CAM-V has the same camera parameters. Here, the camera parameters include intrinsic parameters and extrinsic parameters. The intrinsic parameters include a distortion parameter, a focal length, and the like. The extrinsic parameters include a position and a rotation (orientation) of the camera in the world coordinate system. Camera calibration for determining the camera parameters is performed in advance. In addition, a process of aligning the virtual camera CAM-V in the virtual target space SP-V with the real camera CAM-R in the real target space SP-R is also performed in advance.

The real-to-virtual projection system 1 projects a human in the real target space SP-R onto the virtual target space SP-V. More specifically, a real human present in the real target space SP-R is photographed by the real camera CAM-R. The real-to-virtual projection system 1 detects the real human shown in an image captured (taken) by the real camera CAM-R and estimates a three dimensional (3D) pose of the detected real human. Further, the real-to-virtual projection system 1 generates a virtual human representing (imitating) the real human and having the estimated three dimensional pose. Then, the real-to-virtual projection system 1 projects the virtual human onto the virtual target space SP-V. At this time, the virtual human is projected onto the virtual target space SP-V such that a position of the virtual human in the virtual target space SP-V and a position of the real human in the real target space SP-R coincide with each other with a certain accuracy or more. The projection process described above may be performed in real time.

The real-to-virtual projection system 1 may visualize the virtual target space SP-V and the virtual human projected therein. For example, the real-to-virtual projection system 1 may generate an image of the virtual target space SP-V and the virtual human viewed from the virtual camera CAM-V and display the image on a display device. The visualization process may be performed in real time.

The real-to-virtual projection system 1 may estimate and/or analyze an action of the virtual human projected onto the virtual target space SP-V. The action of the virtual human in the virtual target space SP-V is equivalent to an action of the real human in the real target space SP-R. That is, the real-to-virtual projection system 1 is able to estimate (analyze) the action of the real human in the real target space SP-R by estimating (analyzing) the action of the virtual human in the virtual target space SP-V. In this sense, the real-to-virtual projection system 1 may be referred to as a target space analysis system, a human action estimation system, or the like. Hereinafter, the real-to-virtual projection system 1 is simply referred to as a “system 1.”

The system 1 may be configured by a single node or may be configured by a plurality of nodes. FIG. 1 also shows an example of a configuration of the system 1. The system 1 includes one or more real cameras CAM-R, one or more processors 10, one or more storage devices 20, one or more communication devices 30, one or more input devices 40, and one or more display devices 50.

The processor 10 executes a variety of processing. Examples of the processor 10 include a general-purpose processor, a special-purpose processor, a central processing unit (CPU), a graphics processing unit (GPU), an application specific integrated circuit (ASIC), a field-programmable gate array (FPGA), and the like. It can be said that the processor 10 is processing circuitry. The storage device 20 stores a variety of information necessary for processing. Examples of the storage device 20 include a hard disk drive (HDD), a solid state drive (SSD), a volatile memory, and a nonvolatile memory. The communication device 30 communicates with the outside via a communication network. The input device 40 receives input of a variety of information from a user of the system 1. Examples of the input device 40 include a keyboard, a mouse, a touch panel, a microphone, and the like. The display device 50 displays a variety of information. Examples of the display device 50 include a liquid crystal display, an organic EL display, a head-up display (HUD), and the like.

The processor 10 may execute a computer program. The computer program is stored in the storage device 20. The computer program may be recorded on a non-transitory computer-readable recording medium. The functions of the system 1 may be implemented by the cooperation of the processor 10 that executes the computer program and the storage device 20.

The system 1 will be described in more detail below.

### 2. Various Information and Functions

### 2-1. Virtual Space Configuration Information

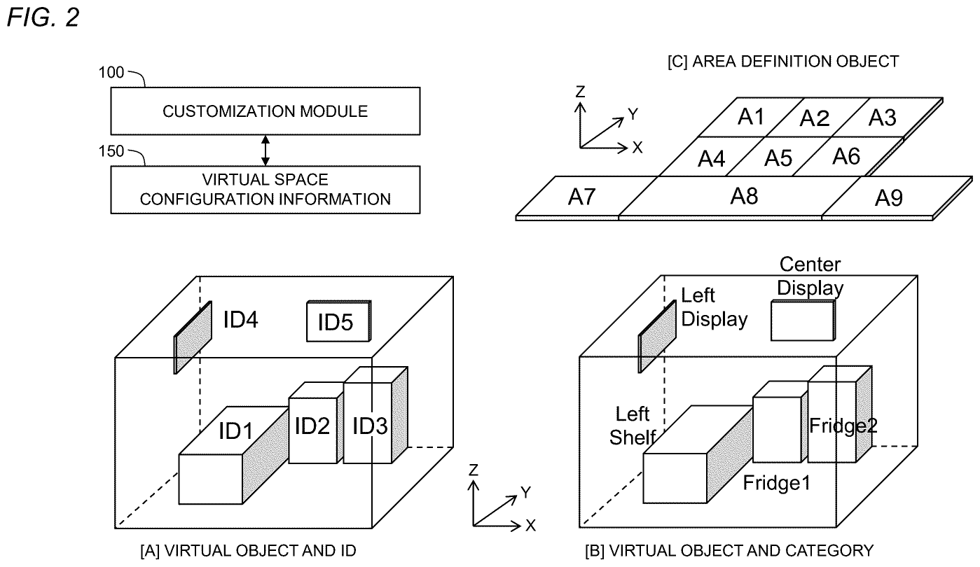

FIG. 2 is a conceptual diagram for explaining virtual space configuration information 150. The virtual space configuration information 150 indicates a configuration of the virtual target space SP-V. More specifically, the virtual space configuration information 150 indicates a “configuration” of each object defined in the virtual target space SP-V. The “configuration” here is a concept including a position, an orientation, a shape, a size, and the like in the world coordinate system (X, Y, Z). For example, each object is represented by a three dimensional bounding box. In this case, the virtual space configuration information 150 includes information for defining a position, an orientation, a size, and the like of the bounding box of each object.

The objects defined in the virtual target space SP-V include the virtual objects corresponding to the real objects in the real target space SP-R. Each virtual object may be assigned identification information (see [A] in FIG. 2). Each virtual object may be given a color. The virtual space configuration information 150 may indicate the identification information and the color of each virtual object. The virtual space configuration information 150 may indicate a “category” of each virtual object (see [B] in FIG. 2). The “category” here means a type of the virtual object (e.g., wall, column, door, desk, chair, shelf, box, display, electronic device, tree, etc.). Further, the virtual space configuration information 150 may include a language explanation of each virtual object.

The objects defined in the virtual target space SP-V may include an area definition object for defining an area in the virtual target space SP-V (see [C] in FIG. 2). The area definition object may be represented by a thin three dimensional bounding box. Identification information may be assigned to each area definition object. Each area definition object may given a color. Further, the virtual space configuration information 150 may include a language description of each area definition object.

The virtual space configuration information 150 is generated in advance and stored in the storage device 20.

The system 1 may include a customization module 100. The customization module 100 provides a function for customizing (editing) the virtual space configuration information 150 to a user. In other words, the customization module 100 provides a user interface for customizing (editing) the virtual space configuration information 150. The customization module 100 displays the virtual space configuration information 150 being edited on the display device 50. The user can freely edit the virtual space configuration information 150 using the input device 40. That is, the user can freely define the virtual object and the area definition object by using the input device 40. The customization module 100 updates the virtual space configuration information 150 according to the input from the user.

### 2-2. Camera Configuration Information

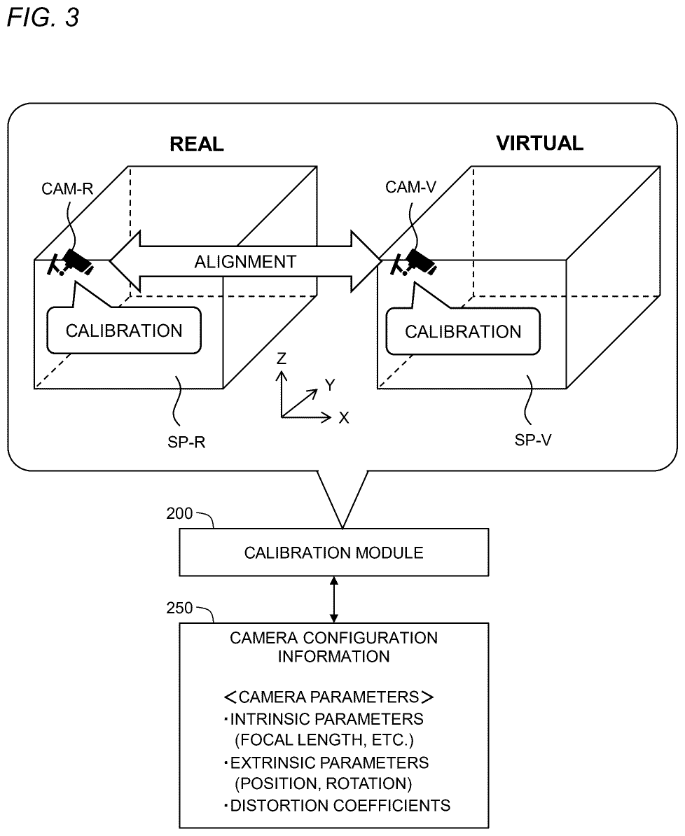

FIG. 3 is a conceptual diagram for explaining camera configuration information 250. The camera configuration information 250 indicates the camera parameters of each real camera CAM-R and each virtual camera CAM-V. The camera parameters include intrinsic parameters and extrinsic parameters. The intrinsic parameters include a distortion parameter, a focal length, and the like. The extrinsic parameters include a position and a rotation (orientation) of the camera in the world coordinate system. The corresponding pair of one real camera CAM-R and one virtual camera CAM-V has the same camera parameters.

The camera configuration information 250 is generated in advance and stored in the storage device 20.

The system 1 may include a calibration module 200. The calibration module 200 performs “camera calibration” that determines the camera parameters of the real camera CAM-R. Moreover, the calibration module 200 performs a “camera alignment process” that corrects the camera parameters so that the real target space SP-R viewed from the real camera CAM-R is aligned (matches) with the virtual target space SP-V. That is, the calibration module 200 performs “camera calibration and alignment process” that determines the camera parameters of the real camera CAM-R so that the real target space SP-R viewed from the real camera CAM-R is aligned (matches) with the virtual target space SP-V. As a result, the camera configuration information 250 indicating the camera parameters is obtained.

It should be noted that a specific example of the camera calibration and alignment process will be described in Section 7 below.

### 2-3. Various Functions

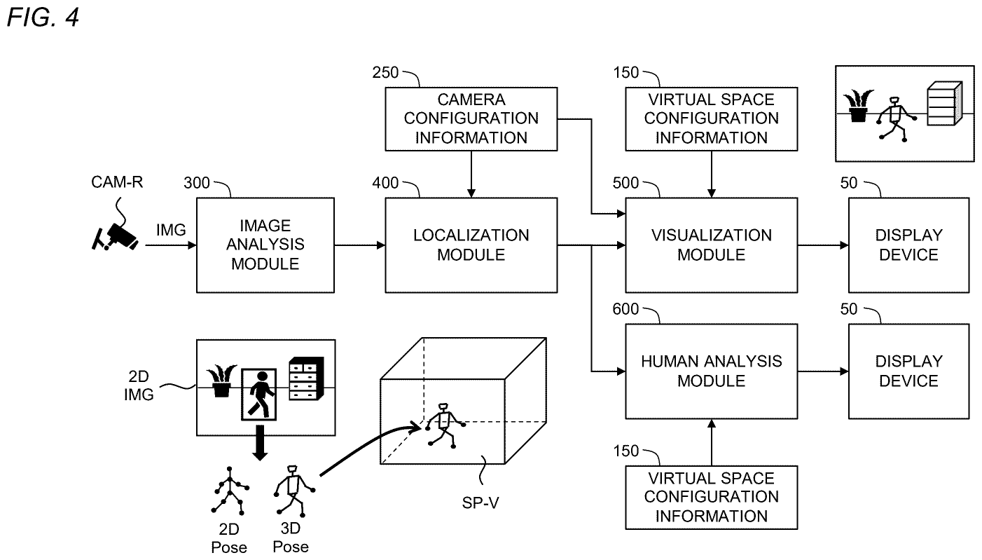

FIG. 4 is a conceptual diagram for explaining an overview of the visualization function and the analysis function of the system 1. The system 1 includes an image analysis module 300, a localization module 400, a visualization module 500, and a human analysis module 600.

The image analysis module 300 acquires a series of two dimensional images IMG captured by the real camera CAM-R installed in the real target space SP-R. The image analysis module 300 detects a real human shown in the two dimensional image IMG. The image analysis module 300 may track the detected real human. The image analysis module 300 may perform a human re-identification process for identifying the same real human across different real cameras CAM-R. The image analysis module 300 estimates a two dimensional pose (2D pose) and a three dimensional pose (3D pose) of the real human based on the two dimensional image IMG. The processing by the image analysis module 300 may be performed in real time. Details of the processing performed by the image analysis module 300 will be described in Section 3 below.

The localization module 400 performs a localization process for estimating a human position in the world coordinate system. A real human position is a position where the real human exists in the real target space SP-R. A virtual human position is a position in the virtual target space SP-V corresponding to the real human position. That is, the virtual human position in the virtual target space SP-V is set to match the real human position in the real target space SP-R. The localization module 400 receives a result of analysis by the image analysis module 300, and estimates the real human position and the virtual human position based on the result of analysis and the camera configuration information 250. Then, the localization module 400 projects (arranges) the virtual human at the virtual human position in the virtual target space SP-V. The virtual human represents (imitates) the real human and has the three dimensional pose estimated by the image analysis module 300. Details of the processing performed by localization module 400 will be described in Section 4 below.

The visualization module 500 visualizes the virtual target space SP-V and the virtual human projected thereon by displaying them on the display device 50. The object configuration in the virtual target space SP-V is obtained from the virtual space configuration information 150. The virtual human has the three dimensional pose as described above. For example, the visualization module 500 may generate an image of the virtual target space SP-V and the virtual human viewed from the virtual camera CAM-V based on the camera configuration information 250, and display the generated image on the display device 50. In this case, a generated image corresponding to the two dimensional image IMG captured by the real camera CAM-R is displayed on the display device 50. The visualization process may be performed in real time. Details of the processing performed by the visualization module 500 will be described in Section 5 below.

The human analysis module 600 analyzes the virtual human projected onto the virtual target space SP-V. For example, the human analysis module 600 performs an “action estimation process” that estimates an action of the virtual human in the virtual target space SP-V based on a relationship between the virtual human having the three dimensional pose and the object configuration in the virtual target space SP-V. The object configuration in the virtual target space SP-V is obtained from the virtual space configuration information 150. The action of the virtual human in the virtual target space SP-V is equivalent to an action of the real human in the real target space SP-R. That is, the human analysis module 600 is able to estimate the action of the real human in the real target space SP-R by estimating the action of the virtual human in the virtual target space SP-V. Since the human's action is estimated based on the relationship between the virtual human having the three dimensional pose and the object configuration, the estimation accuracy is improved as compared with a case where the human's action is directly estimated from the two dimensional image IMG. The processing performed by the human analysis module 600 may be performed in real time. The human analysis module 600 may display a result of the analysis on the display device 50. Details of the processing performed by the human analysis module 600 will be described in Section 6 below.

### 3. Image Analysis Module

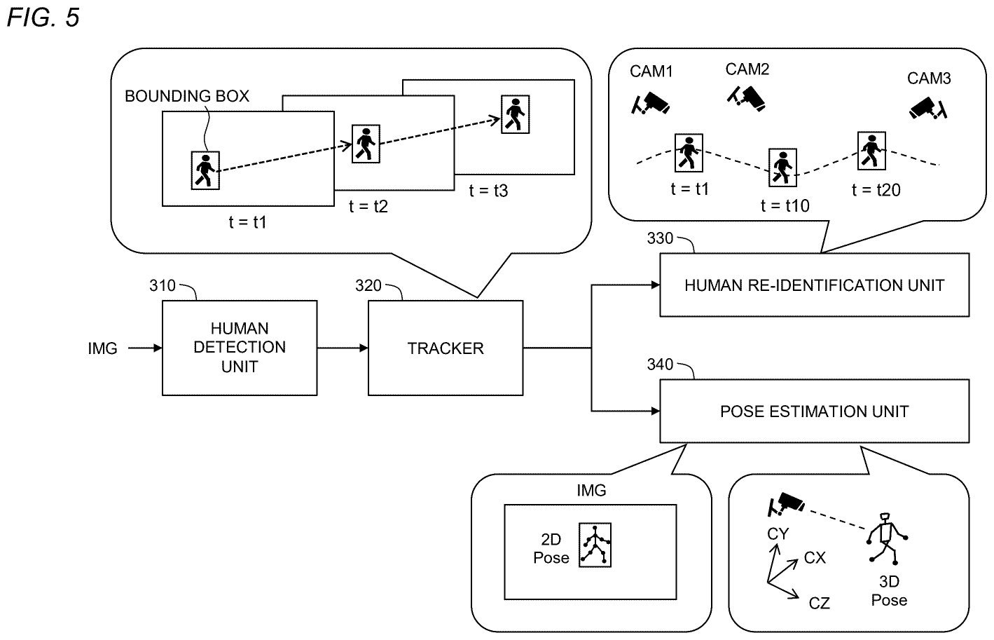

FIG. 5 is a conceptual diagram for explaining an example of the image analysis module 300. The image analysis module 300 includes a human detection unit 310, a tracker 320, a human re-identification unit 330, and a pose estimation unit 340. A sequence of two dimensional images IMG captured by the real camera CAM-R is input to the human detection unit 310. The human detection unit 310 performs a human detection process for detecting a real human shown in each two dimensional image IMG. A bounding box represents the position of the real human detected in the two dimensional image IMG. The human detection process is a well-known technique, and the method thereof is not particularly limited. For example, a YOLOX is used as the human detection unit 310.

The tracker 320 automatically tracks the same real human in the sequence of two dimensional images IMG based on a tracking algorithm. The tracking process is a well-known technique, and the method thereof is not particularly limited. For example, ByteTrack is used as the tracker 320.

The human re-identification unit 330 performs human re-identification for identifying a same real human across different real cameras CAM-R. More specifically, the human re-identification unit 330 acquires a partial image of the real human shown in each two dimensional image IMG. A partial image surrounded by the bounding box in the two dimensional image IMG corresponds to the partial image of the real human. The human re-identification unit 330 extracts a feature amount of the real human (hereinafter, referred to as a “ReID feature amount”) based on the partial image of the real human. Typically, the human re-identification unit 330 extracts the ReID feature amount from each partial image by using a ReID model that is based on machine learning. The ReID model may be a model based on the Transformer. Then, the human re-identification unit 330 calculates a similarity between a first real human and a second real human based on the ReID feature amount of the first real human and the ReID feature amount of the second real human. When the similarity is equal to or greater than a threshold value, the human re-identification unit 330 determines that the first real human and the second real human are the identical real human. Unique human identification information is given to the same real human.

Multi-Target Multi-Camera tracking (MTMC) may be adopted. In the case of MTMC, a plurality of two dimensional images IMG captured by a plurality of real cameras CAM-R are used, and the tracking and human the re-identification are performed in parallel for a plurality of real humans.

The pose estimation unit 340 estimates a two dimensional pose (2D pose) and a three dimensional pose (3D pose) of the real human based on each two dimensional image IMG. More specifically, the pose estimation unit 340 acquires a partial image of the real human shown in each two dimensional image IMG. A partial image surrounded by the bounding box in the two dimensional image IMG corresponds to the partial image of the real human. The pose estimation unit 340 extracts key points from the partial image by using a pose estimation model that is based on machine learning, and estimates the two dimensional pose and the three dimensional pose of the real human. The two dimensional pose is represented in an image coordinate system of the two dimensional image IMG. On the other hand, the three dimensional pose is represented in a camera coordinate system (CX, CY, CZ). Information of the camera coordinate system (CX, CY, CZ) is obtained from the camera configuration information 250. The two dimensional pose and the three dimensional pose are represented by parts such as joints, a head, hands, and feet and lines connecting between the parts. The pose estimation process is a well-known technique, and the method thereof is not particularly limited. For example, MeTRAbs, TransPose, or the like is used for the pose estimation process.

In addition, the image analysis module 300 may detect an attribution of the real human by analyzing the partial image of the real human. The attribute is, for example, gender or age.

### 4. Localization Module

The localization module 400 performs a localization process for estimating a human position in the world coordinate system. A real human position is a position where the real human exists in the real target space SP-R. A virtual human position is a position in the virtual target space SP-V corresponding to the real human position. That is, the virtual human position in the virtual target space SP-V is set to match the real human position in the real target space SP-R.

### 4-1. First Example of Localization Process

In the first example of the localization process, the localization module 400 receives information on the three dimensional pose of the real human from the pose estimation unit 340. The three dimensional pose is represented in the camera coordinate system (CX, CY, CZ). The position of the three dimensional pose of the real human in the camera coordinate system is used as the real human position and the virtual human position in the camera coordinate system. Further, the localization module 400 transforms the real human position and the virtual human position in the camera coordinate system (CX, CY, CZ) into the real human position and the virtual human positions in the world coordinate system (X, Y, Z), respectively, by using the camera configuration information 250. Then, the localization module 400 projects (arranges) the virtual human having the three dimensional pose at the virtual human position in the virtual target space SP-V.

In this manner, in the first example, the human position is estimated based on the position of the three dimensional pose in the camera coordinate system and the camera configuration information 250. However, in order to further improve the estimation accuracy of the human position, a second example described below may be adopted.

### 4-2. Second Example of Localization Process

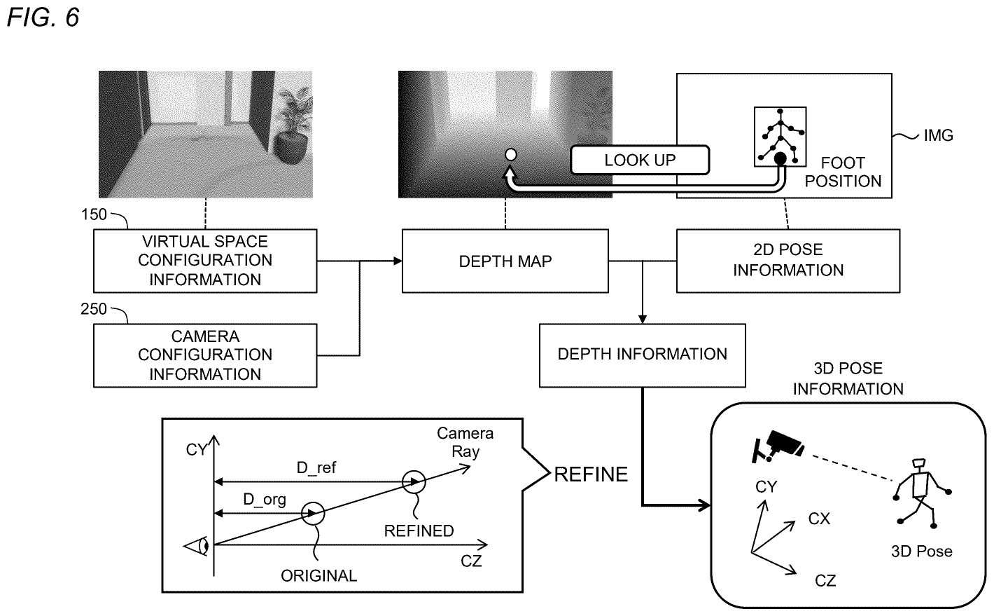

FIG. 6 is a conceptual diagram for explaining a second example of the localization process. First, a depth map of the virtual target space SP-V viewed from the virtual camera CAM-V is prepared in advance. The depth map provides a depth distribution from the virtual camera CAM-V to each object in the virtual target space SP-V. In particular, the depth map provides at least a depth distribution regarding a floor in the virtual target space SP-V. The depth distribution is given in the image coordinate system as seen from the virtual camera CAM-V. Such the depth map is generated, for example, based on the virtual space configuration information 150 indicating the configuration of the virtual target space SP-V and the camera configuration information 250 regarding the virtual camera CAM-V. The depth map is stored in the storage device 20.

The localization module 400 receives information on the “two dimensional pose” of the real human from the pose estimation unit 340. The two dimensional pose is represented in the image coordinate system. The localization module 400 acquires, from the depth map, depth information D_ref regarding the position of the two dimensional pose of the real human in the image. In other words, the localization module 400 uses the depth map as a lookup table (LUT) to acquire the depth information D_ref regarding the position of the two dimensional pose in the image.

In particular, the localization module 400 may focus on a position of a “foot” of the real human. More specifically, the localization module 400 estimates an in-image position of the “foot” of the real human in the two dimensional image IMG based on the information of the two dimensional pose of the real human. For example, the left foot and the right foot of the real human are identified based on the two dimensional pose of the real human, and an intermediate position between the position of the left foot and the position of the right foot is used as the position of the “foot.” Then, the localization module 400 acquires the depth information D_ref regarding the in-image position of the foot of the real human from the depth map.

The three dimensional pose of the real human estimated by the pose estimation unit 340 is represented in the camera coordinate system (CX, CY, CZ). A original depth D_org is depth information of the original three dimensional pose estimated by the pose estimation unit 340. The accuracy of the original depth D_org is not necessarily high. Therefore, the localization module 400 performs the localization process using the depth information D_ref obtained from the depth map instead of the original depth D_org.

For example, the localization module 400 projects the position of the foot of the real human in the image onto a three dimensional position in the camera coordinate system by using the depth information D_ref and the camera configuration information 250. In other words, the localization module 400 projects the position of the foot of the real human in the image onto a three dimensional position corresponding to the depth information D_ref. At this time, a camera ray direction from the camera to the real human is maintained to be the same as the original one (see the explanatory diagram at the lower left of FIG. 6). The three dimensional position obtained in this way is used as the real human position and the virtual human position with high accuracy. It can also be said that the localization module 400 reflects the depth information D_ref obtained from the depth map on the human position while maintaining the original camera ray direction.

Further, the localization module 400 transforms the real human position and the virtual human position in the camera coordinate system (CX, CY, CZ) into the real human position and the virtual human position in the world coordinate system (X, Y, Z) by using the camera configuration information 250. Then, the localization module 400 projects (arranges) the virtual human having the three dimensional pose at the virtual human position in the virtual target space SP-V.

As described above, according to the second example of the localization process, it is possible to improve the accuracy of the localization process by using the depth map. As a result, the accuracy of the projection of the virtual human onto the virtual target space SP-V is also improved, and thus a sense of strangeness with respect to the result of projection of the virtual human can be suppressed. In addition, the improvement in the accuracy of the projection of the virtual human onto the virtual target space SP-V leads to an improvement in the accuracy of the analysis process performed by the human analysis module 600.

Further, the process of acquiring the depth information D_ref from the depth map (lookup table) is extremely simple, the processing load is light, and high-speed processing is possible. The capability of high-speed processing is preferable from the viewpoint of real-time processing (realtimeness). That is, according to the second example of the localization process, it is possible to realize the real-time projection process with high accuracy.

### 5. Visualization Module

The visualization module 500 visualizes the virtual target space SP-V and the virtual human projected thereon by displaying them on the display device 50. The object configuration in the virtual target space SP-V is obtained from the virtual space configuration information 150. The virtual human is depicted as having the estimated three dimensional pose. The virtual human may be depicted as an avatar having the three dimensional pose. The attribute information (e.g., gender, age) obtained by the image analysis module 300 may be reflected in the avatar.

For example, the visualization module 500 may generate an image of the virtual target space SP-V and the virtual human viewed from the virtual camera CAM-V based on the camera configuration information 250, and display the generated image on the display device 50. In this case, a generated image corresponding to the two dimensional image IMG captured by the real camera CAM-R is displayed on the display device 50. The visualization process may be performed in real time.

In the case of MTMC (Multi-Target Multi-Camera tracking), a plurality of two dimensional images IMG captured by a plurality of real cameras CAM-R are used, and tracking and human re-identification are performed in parallel for a plurality of real humans. The visualization module 500 simultaneously displays a plurality of virtual humans corresponding to the plurality of real humans on the display device 50.

Unique human identification information is given to the same real human. It is also considered that the same real human is simultaneously shown in two or more two dimensional images IMG captured by two or more real cameras CAM-R. In this case, since the two dimensional images IMG captured at different angles can be used, the position estimation accuracy of the same real human is improved. On the other hand, in order to avoid two or more virtual humans corresponding to the same real human from being displayed in an overlapping manner, the visualization module 500 may display only a single virtual human for the same real human on the display device 50.

### 6. Human Analysis Module

The human analysis module 600 analyzes the virtual human projected onto the virtual target space SP-V. For example, the human analysis module 600 performs an “action estimation process” that estimates an action of the virtual human in the virtual target space SP—V based on the relationship between the virtual human having the three dimensional pose and the object configuration in the virtual target space SP-V. The object configuration in the virtual target space SP-V is obtained from the virtual space configuration information 150. The action of the virtual human in the virtual target space SP-V is equivalent to an action of the real human in the real target space SP-R. That is, the human analysis module 600 is able to estimate the action of the real human in the real target space SP-R by estimating the action of the virtual human in the virtual target space SP-V. Since the human's action is estimated based on the relationship between the virtual human having the three dimensional pose and the object configuration, the estimation accuracy is improved as compared with a case where the human's action is directly estimated from the two dimensional image IMG.

For example, the human analysis module 600 estimates the action of the virtual human with respect to the virtual objects in the virtual target space SP—V based on the relationship between the virtual human having the three dimensional pose and the configuration of each virtual object. The action of the virtual human with respect to the virtual objects in the virtual target space SP-V is equivalent to the action of the real human with respect to the real objects in the real target space SP-R. That is, the human analysis module 600 may estimate the action of the real human with respect to the real objects in the real target space SP-R by estimating the action of the virtual human with respect to the virtual objects in the virtual target space SP-V. Since the action of the human with respect to the objects is estimated based on the relationship between the virtual human having the three dimensional pose and the object configuration, the estimation accuracy is improved as compared with the case where the action is estimated directly from the two dimensional image IMG.

Hereinafter, a specific example of the action estimation process performed by the human analysis module 600 will be described.

### 6-1. Gaze Estimation Process

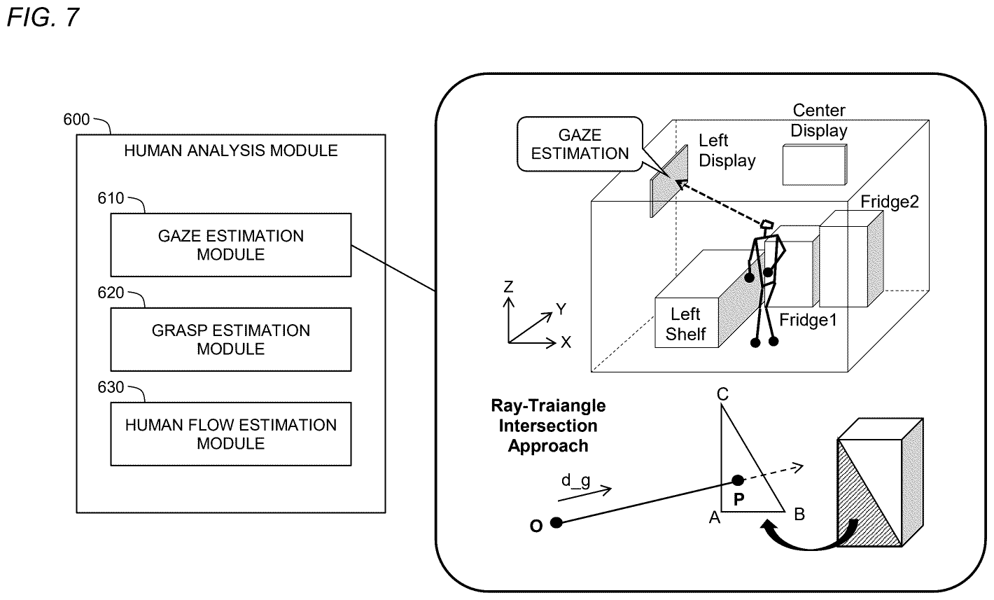

FIG. 7 is a conceptual diagram for explaining an example of a gaze estimation process. The human analysis module 600 includes a gaze estimation module 610 that performs the gaze estimation process. The gaze estimation module 610 estimates which real object the real human is looking at by estimating which virtual object the virtual human is looking at.

More specifically, the gaze estimation module 610 estimates an eye ray of the virtual human based on the information of the virtual human having the three dimensional pose. For example, a direction (orientation) of a face of the virtual human can be known from the three dimensional pose of the virtual human. The direction of the face of the virtual human is regarded as a gaze direction of the virtual human. As another example, the gaze direction may be estimated from the three dimensional pose of the virtual human by using a machine learning model. A line extending in the gaze direction from the position of the face of the virtual human is set as the eye ray. Then, the gaze estimation module 610 determines whether or not the eye ray of the virtual human intersects any of the virtual objects defined in the virtual target space SP-V.

For example, the gaze estimation module 610 determines whether the eye ray intersects any virtual object by a ray-triangle intersection algorithm. For example, when each virtual object is represented by a bounding box, a surface of the bounding box is represented by a combination of 12 triangular planes. In the example shown in FIG. 7, a triangle is defined by three vertices A, B, and C, and the eye ray is represented by a combination of a start point O and a direction d_g. The gaze estimation module 610 calculates an intersection point P between the eye ray and a plane on which the triangle exists. If the intersection point P is within the triangle, then the gaze ray is determined to intersect the virtual object having that triangle. The gaze estimation module 610 can determine whether the eye ray intersects any virtual object by performing the determination process on all triangles defined in the virtual target space SP-V. If it is determined that the eye ray intersects with a plurality of virtual objects, the gaze estimation module 610 selects one virtual object closest to the start point O of the eye ray. The gaze estimation module 610 then estimates the closest virtual object that intersects the eye ray as the virtual object that the virtual human is looking at.

It should be noted that the ray triangle intersection algorithm is just an example, and the present disclosure is not limited thereto. Other shapes may be used instead of a triangle. At least the ray triangle intersection algorithm is extremely simple, has a light processing load, and thus enables high-speed processing. The capability of high-speed processing is preferable from the viewpoint of real-time processing.

As described above, it is possible to estimate which virtual object the virtual human is looking at with high accuracy based on the three dimensional pose of the virtual human and the virtual space configuration information 150. That is, it is possible to estimate which real object the real human is looking at with high accuracy. When the virtual space configuration information 150 indicates the category of each virtual object, it is possible to estimate which real object of which category the real human is looking at with high accuracy. Estimating which real object the real human is looking at makes it possible to know what the real human is interested in, for example.

### 6-2. Grasp Estimation Process

If a hand of the real human is in any real object, it is highly likely that the real human is holding or trying to hold an item stored in the real object. From this viewpoint, a grasp estimation process that estimates whether the real human is grasping something or is trying to grasp something is performed.

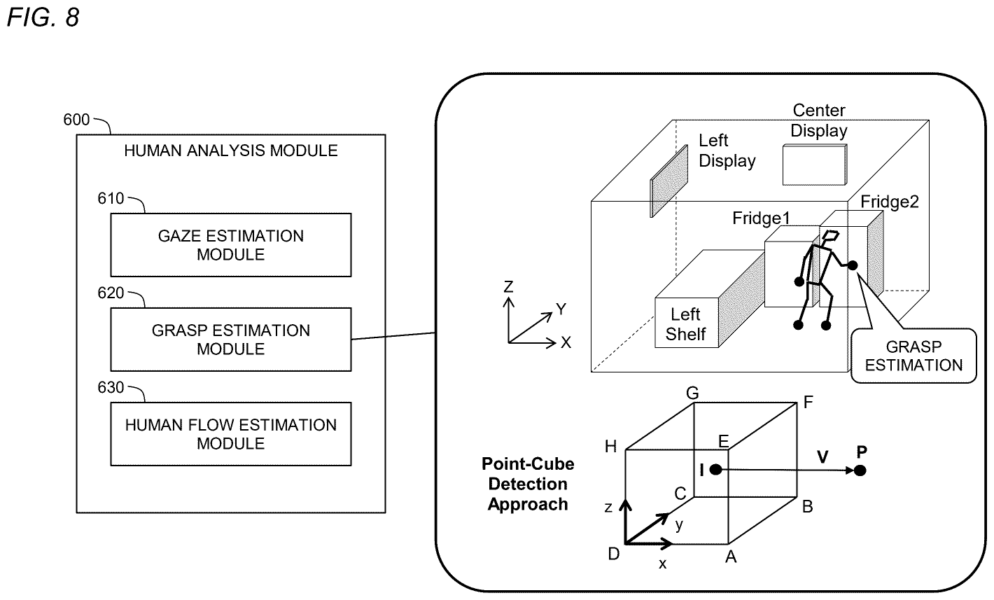

FIG. 8 is a conceptual diagram for explaining an example of the grasp estimation process. The human analysis module 600 includes a grasp estimation module 620 that performs the grasp estimation process. The grasp estimation module 620 estimates whether a hand of the real human is in any real object by estimating whether a hand of the virtual human is in any virtual object.

More specifically, the grasp estimation module 620 estimates a position of a hand of the virtual human based on the information of the virtual human having the three dimensional pose. That is, the grasp estimation module 620 estimates a position of a hand of the three dimensional pose as the position of the hand of the virtual human. Then, the grasp estimation module 620 determines whether or not the hand of the virtual human is present in any of the virtual objects defined in the virtual target space SP-V.

For example, the grasp estimation module 620 determines whether the hand of the virtual human is in any of the virtual objects by a point-cube detection algorithm. For example, each virtual object is represented by a bounding box. In the example illustrated in FIG. 8, the bounding box of a certain virtual object is defined by vertices A to H. A position of a center point I of the bounding box is calculated from the positions of the vertices D and F (i.e., I=(D+F)/2), for example. A point P is the position of the hand of the virtual human. A vector V from the center point I to the point P is defined. The three axes defining the bounding box are an x-axis, a y-axis, and a z-axis. [Vx, Vy, Vz] are the x-axis component, the y-axis component, and the z-axis component of the vector V. Lx, Ly, and Lz are the lengths of the bounding box along the x-axis direction, the y-axis direction, and the z-axis direction. The grasp estimation module 620 determines whether or not the following condition “2×Vx≤Lx, 2×Vy≤Ly, 2×Vz≤Lz” is satisfied. If the condition is satisfied, it is determined that the point P is within the bounding box. That is to say, the hand of the virtual human is estimated to be within the virtual object represented by the bounding box.

It should be noted that the point cube detection algorithm is just an example, and the present disclosure is not limited thereto. However, the point cube detection algorithm is extremely simple, has a light processing load, and thus enables high-speed processing. The capability of high-speed processing is preferable from the viewpoint of real-time processing.

In this manner, it is possible to estimate with high accuracy whether the hand of the virtual human is in any of the virtual objects based on the three dimensional pose of the virtual human and the virtual space configuration information 150. That is, it is possible to estimate whether the hand of the real human is in any real object with high accuracy. When the hand of the real human is in any real object, it can be determined that at least the real human is interested in an item in the real object. In addition, when the hand of the real human is in any real object, the real human is highly likely to be holding or trying to hold an item in the real object. Therefore, the grasp estimation process makes it possible to roughly estimate whether the real human is gripping something or is trying to grip something. When the virtual space configuration information 150 indicates the category of each virtual object, it is also possible to specify the item held or to be held by the real human in more detail.

### 6-3. Human Flow Estimation Process

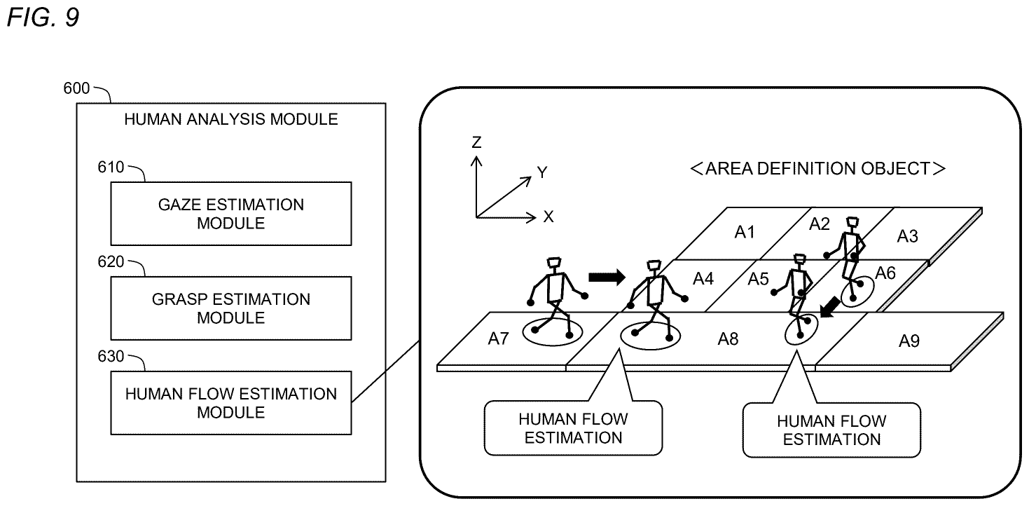

FIG. 9 is a conceptual diagram for explaining an example of a human flow estimation process. The human analysis module 600 includes a human flow estimation module 630 that performs the human flow estimation process. The human flow estimation module 630 estimates a flow of the real human in the real target space SP-R by estimating a flow of the virtual human in the virtual target space SP-V.

The area definition object is used for the human flow estimation process (see [C] in FIG. 2). The area definition object is an object for defining an area in the virtual target space SP-V. The virtual space configuration information 150 indicates the configuration of each area definition object defined in the virtual target space SP-V. The human flow estimation module 630 estimates the flow of the virtual human in the virtual target space SP-V based on a relationship between the virtual human having the three dimensional pose and the configuration of the area definition objects.

More specifically, the human flow estimation module 630 estimates a position of a foot of the virtual human based on the information of the virtual human having the three dimensional pose. For example, a left foot and a right foot of the virtual human are identified based on the three dimensional pose of the virtual human, and an intermediate position between the position of the left foot and the position of the right foot is used as the position of the “foot.” Then, the human flow estimation module 630 determines which area definition object the foot of the virtual human is in. This determination is made, for example, based on the point cube detection algorithm described in Section 6-2 above. The human flow estimation module 630 recognizes an area definition object in which the foot of the virtual human exist, and determines that the virtual human is positioned in an area defined by the area definition object. Further, the human flow estimation module 630 estimates the flow of the virtual human in the virtual target space SP-V by detecting a change in the area where the virtual human is located.

In this manner, the flow of the virtual human in the virtual target space SP-V can be estimated with high accuracy based on the three dimensional pose of the virtual human and the virtual space configuration information 150. That is, the flow of real humans in the real target space SP-R can be estimated with high accuracy. The flow of real human in the real target space SP-R can be used for various purposes. For example, based on the flow of real humans in the real target space SP-R, a congestion situation in the real target space SP-R can be investigated, and a cause of congestion can be identified. As another example, it is possible to analyze what the real human is interested in based on the flow of the real human in the real target space SP-R.

### 6-4. Display of Analysis Result

The human analysis module 600 displays a result of the analysis on the display device 50. The result of analysis may be statistical information or time transition information. The information may be classified for each attribute (for example, gender and age) of the human.

### 7. Example of Camera Calibration and Alignment Process

The calibration module 200 performs the camera calibration for determining the camera parameters of the real camera CAM-R. The calibration module 200 performs the “camera alignment process” that corrects the camera parameters so that the real target space SP-R viewed from the real camera CAM-R is aligned with the virtual target space SP-V. That is, the calibration module 200 performs the “camera calibration and alignment process” for determining the camera parameters of the real camera CAM-R so that the real target space SP-R viewed from the real camera CAM-R is aligned with the virtual target space SP-V. Performing the camera calibration and alignment process makes it possible to secure the accuracy of the localization process (see Section 4), the accuracy of the visualization process (see Section 5), and the accuracy of the human analysis process (see Section 6).

A specific example of the camera calibration and alignment process will be described below.

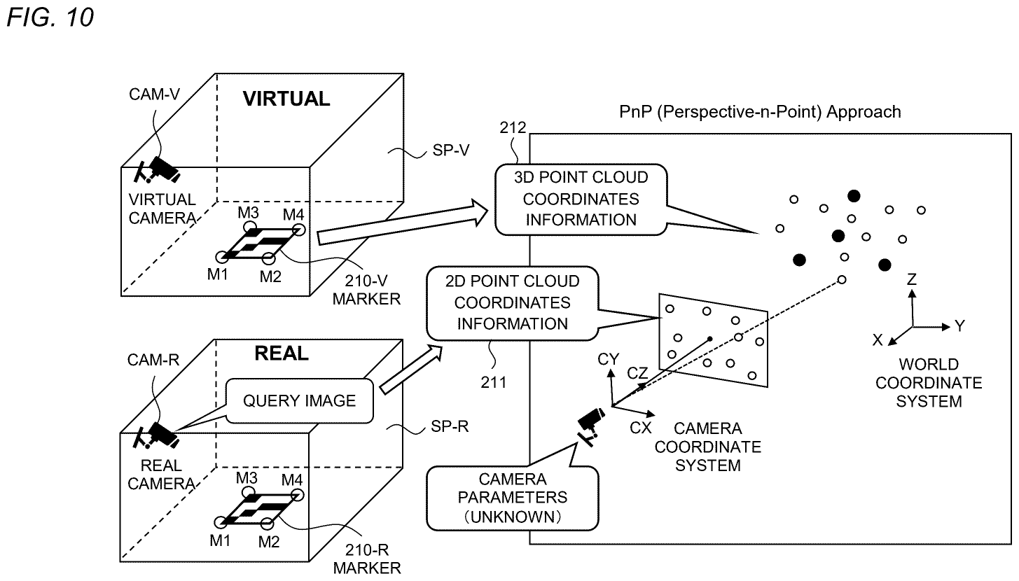

FIG. 10 is a conceptual diagram for explaining an example of the camera calibration and alignment process. In the present example, the camera calibration is performed based on a Perspective-n-Point (PnP) method. In the PnP method, a point cloud including n points is used. Here, n is an integer of 2 or more. Three dimensional point cloud coordinates information is coordinates information of the point cloud in the three dimensional space (i.e., the world coordinate system). The two dimensional point cloud coordinates information is coordinates information of the point cloud in the image coordinate system when the point cloud is captured by the camera. When the three dimensional point cloud coordinates information and the two dimensional point cloud coordinates information are given, the camera parameters can be calculated by solving the PnP problem.

In the present example, the point cloud (n points) is acquired from a marker 210 which is a mark arranged in the space. For example, the marker 210 is a quadrangle, and four vertices M1 to M4 of the quadrangle are used as the point cloud. The marker 210 has a predetermined pattern and can be recognized on the image.

More specifically, a real marker 210-R is placed at a predetermined real position in the real target space SP-R, which is photographed by the real camera CAM-R. On the other hand, a virtual marker 210-V is placed at a predetermined virtual position in the virtual target space SP-V, which is captured by the virtual camera CAM-V. Here, the predetermined virtual position in the virtual target space SP-V is a position corresponding to the predetermined real position in the real target space SP-R. The real marker 210-R and the virtual marker 210-V have the same shape, orientation, and pattern. Therefore, the point cloud (vertices M1 to M4) of the virtual marker 210-V corresponds to the point cloud (vertices M1 to M4) of the real marker 210-R. The customization module 100 shown in FIG. 2 is used for placing the virtual marker 210-V at the predetermined virtual position in the virtual target space SP-V.

The calibration module 200 acquires a two dimensional image IMG captured by the real camera CAM-R installed in the real target space SP-R as a query image. The query image includes the real marker 210-R placed at the predetermined real position. The calibration module 200 has configuration information of the marker 210 and performs pattern matching to detect the real marker 210-R and the point cloud (four vertices M1 to M4) in the query image. Then, the calibration module 200 acquires the position of the point cloud in the query image as the “two dimensional point cloud coordinates information 211.”

Meanwhile, the calibration module 200 acquires the position of the point cloud (four vertices M1 to M4) of the virtual marker 210-V in the virtual target space SP-V as the “three dimensional point cloud coordinates information 212.” The position of the point cloud of the virtual marker 210-V in the virtual target space SP-V is obtained from the virtual space configuration information 150.

The calibration module 200 determines the camera parameters by solving the PnP problem based on the two dimensional point cloud coordinates information 211 and the three dimensional point cloud coordinates information 212 thus obtained. What is important here is that the present approach is able to achieve the camera alignment at the same time with the determination of the camera parameters. Since the two dimensional point cloud coordinates information 211 obtained from the real target space SP-R and the three dimensional point cloud coordinates information 212 obtained from the virtual target space SP-V are combined, the camera alignment is achieved concurrently with the determination of the camera parameters.

As described above, according to the present embodiment, both the camera calibration and the camera alignment process can be realized in one step. This is preferable from the viewpoint of reducing the processing load.

What is claimed is:

1. A projection system comprising:
processing circuitry; and
one or more storage devices configured to store virtual space configuration information indicating a configuration of objects defined in a virtual target space representing a real target space, wherein
the processing circuitry is configured to:
detect a real human shown in an image taken by a real camera installed in the real target space;
estimate a three dimensional pose of the real human based on the image;
project a virtual human having the three dimensional pose and representing the real human onto the virtual target space; and
perform an action estimation process that estimates an action of the real human in the real target space by estimating an action of the virtual human in the virtual target space based on a relationship between the virtual human having the three dimensional pose and the configuration of the objects in the virtual target space.

2. The projection system according to claim 1, wherein
the objects defined in the virtual target space include virtual objects corresponding to real objects present in the real target space, and
in the action estimation process, the processing circuitry is further configured to estimate an action of the real human with respect to the real objects in the real target space by estimating an action of the virtual human with respect to the virtual objects in the virtual target space based on a relationship between the virtual human having the three dimensional pose and the configuration of the virtual objects in the virtual target space.

3. The projection system according to claim 2, wherein
the action estimation process includes a gaze estimation process that estimates which real object the real human looks at by estimating which virtual object the virtual human looks at.

4. The projection system according to claim 3, wherein
the gaze estimation process includes:
estimating an eye ray of the virtual human based on the three dimensional pose of the virtual human; and
estimating which virtual object the virtual human looks at by determining whether the eye ray intersects with any virtual object defined in the virtual target space.

5. The projection system according to claim 2, wherein
the action estimation process includes a grasp estimation process that estimates whether a hand of the real human is in any real object by estimating whether a hand of the virtual human is in any virtual object.

6. The projection system according to claim 1, wherein
the objects defined in the virtual target space include area-defining objects for defining areas in the virtual target space, and
in the action estimation process, the processing circuitry is further configured to perform a human flow estimation process that estimates a flow of the real human in the real target space by estimating a flow of the virtual human in the virtual target space based on a relationship between the virtual human having the three dimensional pose and a configuration of the area-defining objects.
